(19) United States
(12) Patent Application Publication
(10) Pub. No.: US 2024/0336260 A1
(43) Pub. Date: Oct. 10, 2024

(54) RUNNING CONTROL DEVICE AND METHOD FOR A VEHICLE

(71) Applicant: TOYOTA JIDOSHA KABUSHIKI KAISHA, Toyota-shi (JP)

(72) Inventors: Kaoru SHIMURA, Toyota-shi (JP); Yuki TEZUKA, Toyota-shi (JP); Koki SUWABE, Toyota-shi (JP)

(73) Assignee: TOYOTA JIDOSHA KABUSHIKI KAISHA, Toyota-shi (JP)

(21) Appl. No.: 18/625,832

(22) Filed: Apr. 3, 2024

(30) Foreign Application Priority Data
Apr. 5, 2023 (JP) 2023-061166

(51) Int. Cl. B60W 30/12; B60W 10/20; G06V 20/56

(52) U.S. Cl. CPC B60W 30/12; B60W 10/20; G06V 20/588; B60W 2420/403; B60W 2520/125; B60W 2520/14; B60W 2552/30; B60W 2552/53

(57) ABSTRACT

A running control device for a vehicle comprising a lane information acquisition device and an electronic control unit that performs a running control in which a target steering angle for bringing a lateral position of the vehicle with respect to a lane to a target position is calculated and an automatic steering device is controlled so that a steering angle becomes the target steering angle, and is configured to calculate a lane curvature based on lane information, calculate an estimated lateral acceleration of the vehicle based on the lane curvature, obtain information about a lane cant in front of the vehicle, and calculate an estimated cant lateral acceleration based on the lane cant, and perform no running control when a magnitude of the estimated lateral acceleration of the vehicle which is corrected by subtracting the estimated cant lateral acceleration exceeds a determination reference value.

### CROSS-REFERENCE TO RELATED APPLICATION

This application claims priority to Japanese Patent Application No. JP2023-061166 filed on Apr. 5, 2023, the content of which is hereby incorporated by reference in its entirety into this application.

### BACKGROUND

### 1. Technical Field

The present disclosure relates to a running control device and method for a vehicle such as an automobile.

### 2. Description of the Related Art

As one type of running control device for a vehicle such as an automobile, a running control device that controls running of a vehicle so that a lateral position of the vehicle with respect to a lane becomes a target position is well known. As this type of running control device, a lane keeping assistance device, a lane departure prevention device, and a lane change assistance device are known. Note that in this application, lane keeping assistance control is referred to as LKA (abbreviation for Lane Keeping Assistance).

In running control using a running control device such as LKA, if a high centrifugal force acts on a vehicle when the vehicle runs on a curve, it may not be possible to control running of the vehicle so that a lateral position of the vehicle with respect to a lane becomes a target position. Therefore, it is known that in a situation where a high centrifugal force acts on the vehicle, the running control by the running control device is cancelled.

For example, in Japanese Patent Application Laid-open No. 2020-104829, it is described that when a curvature of a lane in front of a vehicle or a lateral acceleration of the vehicle exceeds a respective reference value, it is determined that a lateral force acting on the vehicle exceeds a LKA control limit and a driver is notified of handover of driving operation and degeneration of the LKA control is performed.

When a vehicle runs on a curve with a cant, not only a centrifugal force acts on the vehicle, but also a lateral force due to the cant acts in the opposite direction to the centrifugal force. Therefore, the lateral force that acts on the vehicle when the vehicle runs on a curve with a cant is smaller than a lateral force that acts on the vehicle when the vehicle runs on a curve without a cant.

Based on a lane curvature (and vehicle speed), it is possible to estimate a future lateral acceleration of the vehicle and determine without delay whether a lateral force acting on the vehicle exceeds a limit of vehicle running control. However, a lateral acceleration estimated based on the lane curvature (and vehicle speed) does not reflect a lateral force caused by a cant. Therefore, even though the lateral force acting on the vehicle does not exceed the limit of vehicle running control, the lateral force acting on the vehicle may be determined to be exceeding the limit of vehicle running control, and the vehicle running control may be canceled unnecessarily.

On the other hand, an actual lateral acceleration of the vehicle is a value corresponding to a lateral force obtained by subtracting a lateral force caused by a cant from the centrifugal force, but it is not possible to estimate a lateral force that will act on the vehicle in the future based on the actual lateral acceleration of the vehicle. Therefore, there may be a delay in determining whether to cancel the vehicle running control.

### SUMMARY

The present disclosure provides a vehicle running control device and a vehicle running control method that are improved to determine whether or not to cancel vehicle running control when a vehicle runs on a curve, without unnecessary cancelling of the vehicle running control and without causing a delay in determining whether to cancel the vehicle running control.

According to the present disclosure, a running control device for a vehicle is provided which comprises a lane information acquisition device that acquires information about a lane in front of the vehicle, an automatic steering device that automatically steers steered wheels, and an electronic control unit that controls the automatic steering device, the electronic control unit is configured to perform a running control in which the electronic control unit calculates a target steering angle for bringing a lateral position of the vehicle with respect to the lane to a target position, and controls the automatic steering device so that a steering angle becomes the target steering angle.

The electronic control unit is configured to calculate a curvature of the lane based on information about the lane, calculate an estimated lateral acceleration of the vehicle based on the curvature of the lane, obtain information about a cant of the lane in front of the vehicle, and calculate an estimated cant lateral acceleration based on the cant of the lane, and is configured not to perform the running control when a magnitude of a corrected estimated lateral acceleration of the vehicle which is obtained by subtracting the estimated cant lateral acceleration from the estimated lateral acceleration of the vehicle exceeds a determination reference value.

According to the present disclosure, a running control method for a vehicle is provided which comprises a step of obtaining information about a lane in front of the vehicle and calculating a target steering angle to bring a lateral position of the vehicle relative to the lane to a target position, and a step of perform a running control including controlling an automatic steering device to automatically steer steered wheels so that a steering angle becomes the target steering angle.

The running control method further comprises a step of calculating a curvature of the lane based on information about the lane to calculate an estimated lateral acceleration of the vehicle based on the curvature of the lane, a step of obtaining information about a cant of the lane in front of the vehicle to calculate an estimated cant lateral acceleration based on the cant of the lane, and a step of executing no running control when a magnitude of a corrected estimated lateral acceleration of the vehicle which is obtained by subtracting the estimated cant lateral acceleration from the estimated lateral acceleration of the vehicle exceeds a determination reference value.

According to the running control device and the running control method, an estimated lateral acceleration of the vehicle is calculated based on a curvature of the lane in front of the vehicle, and an estimated cant lateral acceleration is calculated based on a cant of the lane in front of the vehicle. Further, when a magnitude of a corrected estimated lateral acceleration of the vehicle which is obtained by subtracting the estimated cant lateral acceleration from the estimated lateral acceleration of the vehicle exceeds a determination reference value, the running control is not performed.

The corrected estimated lateral acceleration of the vehicle which is obtained by subtracting the estimated cant lateral acceleration from the estimated lateral acceleration of the vehicle is a lateral acceleration corresponding to a centrifugal force reduced by a lateral force acting on the vehicle due to a cant of the lane, that is, a lateral acceleration corresponding to a lateral force actually acting on the vehicle.

Therefore, it is possible to prevent the lateral force acting on the vehicle from being determined to exceed the limit of the running control of the vehicle and to prevent the running control from being cancelled unnecessarily even though the lateral force actually acting on the vehicle does not exceed the limit of the running control.

Further, the estimated lateral acceleration of the vehicle is calculated based on a curvature of the lane in front of the vehicle, and the estimated cant lateral acceleration is calculated based on a cant of the lane in front of the vehicle. Therefore, the corrected estimated lateral acceleration of the vehicle which is obtained by subtracting the estimated cant lateral acceleration from the estimated lateral acceleration of the vehicle is a lateral acceleration corresponding to a lateral force that will actually act on the vehicle in the future. Accordingly, it is possible to prevent a delay in determining whether or not to cancel the vehicle running control.

In one aspect of the present disclosure, the electronic control unit is configured not to perform the running control when an magnitude of the estimated lateral acceleration of the vehicle exceeds the determination reference value, if the electronic control unit determines that the estimated cant lateral acceleration is not calculated with accuracy higher than or equal to a predetermined standard.

In another aspect of the present disclosure, the electronic control unit is configured to obtain information about vehicle speed, vehicle yaw rate, and vehicle lateral acceleration, calculate an actual cant lateral acceleration by subtracting the vehicle lateral acceleration from a product of the vehicle speed and the vehicle yaw rate, and determine that the estimated cant lateral acceleration is not calculated with accuracy higher than or equal to the predetermined standard when a magnitude of a difference between the actual cant lateral acceleration and the estimated cant lateral acceleration calculated for a position where the information about the vehicle lateral acceleration was acquired exceeds a reference value for the difference.

Further, in another aspect of the present disclosure, the electronic control unit stores a relationship between road curvatures and road cants based on a road structure regulation, and is configured to acquire information about a cant of the lane from the relationship based on a curvature of the lane.

In this application, an estimated cant lateral acceleration is a component of the gravitational acceleration that is estimated based on a cant of a lane, and is an acceleration that corresponds to a force that is estimated to act laterally on the vehicle due to the cant. An actual cant lateral acceleration is a component of the gravitational acceleration in the lateral inclination direction of a road due to the cant of the lane, and is an acceleration that corresponds to a force acting on the vehicle in the lateral direction due to the cant. Furthermore, in this application, “lane” means a running area for vehicles divided by white lines, curbs, road boundaries, etc.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a running control device according to an embodiment of the present disclosure.

FIG. 2 is a flowchart showing a LKA routine in the embodiment.

FIG. 3 is a flowchart showing a routine for setting flags Fs and Fi in the embodiment.

FIG. 4 is a diagram for explaining an estimated cant lateral acceleration Gkp.

FIG. 5 is a diagram showing lateral accelerations of a vehicle when the vehicle runs on a curve without a cant.

FIG. 6 is a diagram showing lateral accelerations of a vehicle when the vehicle runs on a curve with a cant.

### DETAILED DESCRIPTION

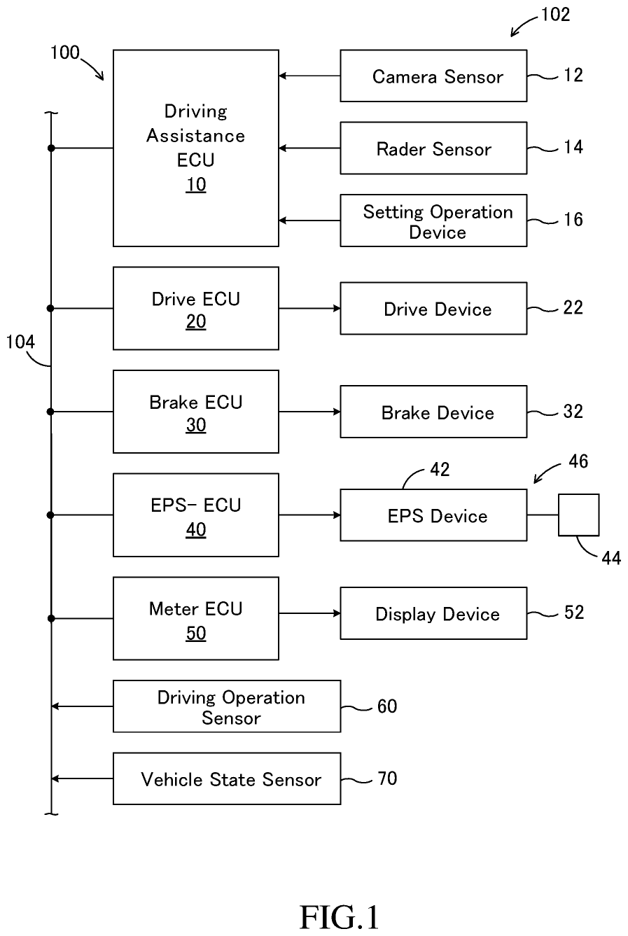

As shown in FIG. 1, a running control device 100 according to an embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, an electric power steering ECU 40, and a meter ECU 50. ECU means an electronic control unit having a microcomputer as its main part. In the following description, the electric power steering will be referred to as EPS.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control for the vehicle such as the LKA. In the embodiment, the driving assistance ECU 10 cooperates with other ECUs to perform the LKA, as will be described in detail later.

A camera sensor 12 and a radar sensor 14 are connected to the driving assistance ECU 10. The camera sensor 12 and the radar sensor 14 include a plurality of camera devices and a plurality of radar devices, respectively. The radar sensor 14 may be omitted, and LiDAR (Light Detection And Ranging) may be used instead of or in addition to the radar sensor 14.

Although not shown in FIG. 1, each camera device of the camera sensor 12 includes a camera unit that captures images of the surroundings of the vehicle 102, and a recognition unit that analyzes the image data captured by the camera unit and recognizes targets such as white lines on a road and other vehicles. The recognition unit supplies information about a recognized targets to the driving assistance ECU 10 every time a predetermined time elapses. Therefore, the camera sensor 12 functions as a lane information acquisition device that acquires information about a lane in front of the vehicle 102.

Further, a setting operation device 16 is connected to the driving assistance ECU 10, and the setting operation device 16 is provided at a position to be operated by a driver. Although not shown in FIG. 1, in the embodiment, the setting operation device 16 includes an LKA switch, and the driving assistance ECU 10 performs the LKA when the LKA switch is on.

The drive ECU 20 is connected to a drive device 22 that accelerates the vehicle 102 by applying driving force to drive wheels (not shown in FIG. 1). The drive ECU 20 normally controls the drive device 22 so that the driving force generated by the drive device 22 changes according to a driving operation by the driver, and when the drive ECU 20 receives a command signal from the driving assistance ECU 10, the drive ECU 20 controls the drive device 22 based on the command signal.

The brake ECU 30 is connected to a brake device 32 that decelerates the vehicle 102 by applying braking force to wheels (not shown in FIG. 1). The brake ECU 30 normally controls the brake device 32 so that the braking force generated by the brake device 32 changes according to a braking operation by the driver, and, when the brake ECU 30 receives a command signal from the driving assistance ECU 10, the brake ECU 30 performs automatic braking by controlling the brake device 32 based on a command signal. Therefore, the brake ECU 30 and the brake device 32 function as an automatic brake device.

The EPS-ECU 40 is connected to an EPS device 42. The EPS-ECU 40 controls the EPS device 42 in a manner known in the art based on a steering torque Ts and a vehicle speed V detected by a driving operation sensor 60 and a vehicle state sensor 70, which will be described later, to control a steering torque and reduce the driver's steering burden. Further, the EPS-ECU 40 can steer steered wheels 44 as necessary by controlling the EPS device 42. Therefore, the EPS-ECU 40 and the EPS device 42 function as an automatic steering device 46 that automatically steers the steered wheels 44 as necessary.

A display device 52 that displays status of the control by the driving assistance ECU 10 is connected to the meter ECU 50. The display device 52 may be, for example, a multi-information display on which meters and various pieces of information are displayed, or may be a display of a navigation device (not shown).

The driving operation sensor 60 and the vehicle state sensor 70 are connected to the CAN 104. Information detected by the driving operation sensor 60 and the vehicle state sensor 70 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a driving operation amount sensor and a braking operation amount sensor. Further, the driving operation sensor 60 includes a steering angle sensor, a steering torque sensor, and the like. The vehicle state sensor 70 includes a vehicle speed sensor, a longitudinal acceleration sensor, a lateral acceleration sensor, a yaw rate sensor, and the like.

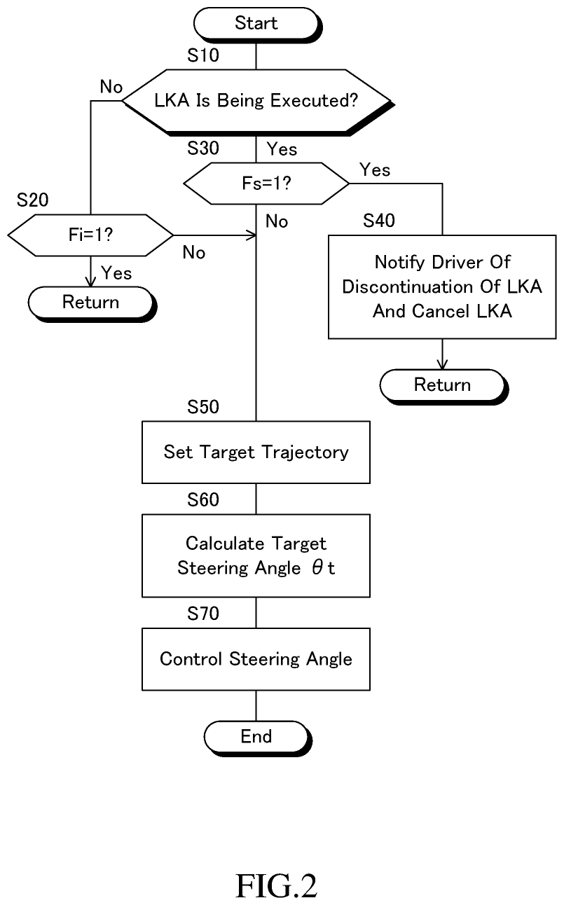

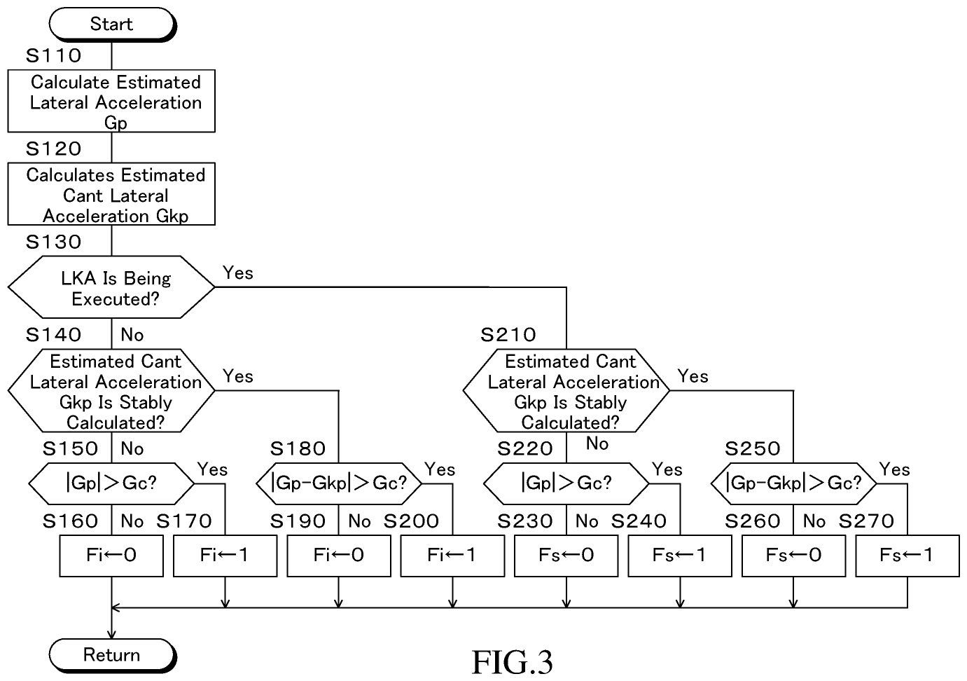

In the embodiment, the ROM of the driving assistance ECU 10 stores a LKA program corresponding to the flowchart shown in FIG. 2. The CPU performs the LKA in the embodiment according to this program. Further, the ROM of the driving assistance ECU 10 stores a setting program for flags Fs and Fi corresponding to the flowchart shown in FIG. 3. The CPU sets the flags Fs and Fi according to this program. Further, the ROM of the driving assistance ECU 10 stores a relationship between road curvatures C and cants K based on a road structure regulation as a map.

### LKA Routine in Embodiment

Next, the LKA routine in the embodiment will be explained with reference to the flowchart shown in FIG. 2. The LKA according to the flowchart shown in FIG. 2 is repeatedly executed by the CPU of the driving assistance ECU 10 when the LKA switch (not shown in FIG. 1) of the setting operation device 16 is on.

First, in step S10, the CPU determines whether or not the LKA is being executed, that is, whether or not steps S50 to S70, which will be described later, are being executed. When an affirmative determination is made, the present control proceeds to step S30, and when a negative determination is made, the present control proceeds to step S20.

In step S20, the CPU determines whether or not the flag Fi is 1, that is, whether or not it is necessary to suppress execution of the LKA. When an affirmative determination is made, the present control is once terminated without starting the LKA, and when a negative determination is made, the present control proceeds to step S50.

In step S30, the CPU determines whether or not the flag Fs is 1, that is, whether or not it is necessary to cancel the LKA. When a negative determination is made, the present control proceeds to step S50, and when an affirmative determination is made, the present control proceeds to step S40.

In step S40, the CPU outputs a command signal to the meter ECU 50 to operate the display device 52 and notify the driver of discontinuation of the LKA. Furthermore, the CPU gradually decreases a control amount of the LKA, that is, a control amount for making the steering angle θ to a target steering angle θt calculated in step S60, which will be described later, until it reaches a predetermined value, and cancels the LKA.

In step S50, the CPU sets a target trajectory for the vehicle 102 to run along a lane, based on a white line or white lines detected by the camera sensor 12, using any method known in the art. Note that when there is a preceding vehicle, the target trajectory may be set based on a running locus of the preceding vehicle.

In step S60, the CPU calculates a target steering angle θt for the vehicle 102 to run along the target trajectory. The target steering angle θt may be calculated using any method known in the art, such as the method described in Japanese Laid-open application No. 2017-35925, for example.

In step S70, the CPU outputs a command signal to the EPS-ECU 40 and controls the steering angle by the automatic steering device 46 so that an actual steering angle θ becomes the target steering angle θt, that is, so that a difference between the target steering angle θt and the actual steering angle θ becomes small.

The LKA is executed in steps S50 to S70 above, The fact that the LKA is being executed and its contents may be displayed on the display device 52.

### <Setting Routine for Flags Fs and Fi>

Next, a setting routine for the flags Fs and Fi will be explained with reference to the flowchart shown in FIG. 3. The control according to the flowchart shown in FIG. 3 is repeatedly executed by the CPU of the driving assistance ECU 10 when the LKA switch (not shown in FIG. 1) of the setting operation device 16 is on. Note that at the start of the control according to the flowchart shown in FIG. 3, the flags Fs and Fi are initialized to 0.

First, in step S110, the CPU estimates a curvature C of a lane in front of the vehicle 102 based on a white line or white lines detected by the camera sensor 12. Furthermore, the CPU calculates an estimated lateral acceleration Gp generated when the vehicle 102 will passes a position where the curvature C of the lane was estimated by calculating a product CV² of the curvature C of the lane and a square of a vehicle speed V.

In step S120, the CPU determines a cant K of a road at the position where the curvature C of the lane was estimated from the map of the relationship between the curvatures C of roads and the cants K, based on the curvature C of the lane. Further, the CPU calculates an estimated cant lateral acceleration Gkp based on the cant K as a component of the gravitational acceleration in a lateral slope direction of the road due to the cant.

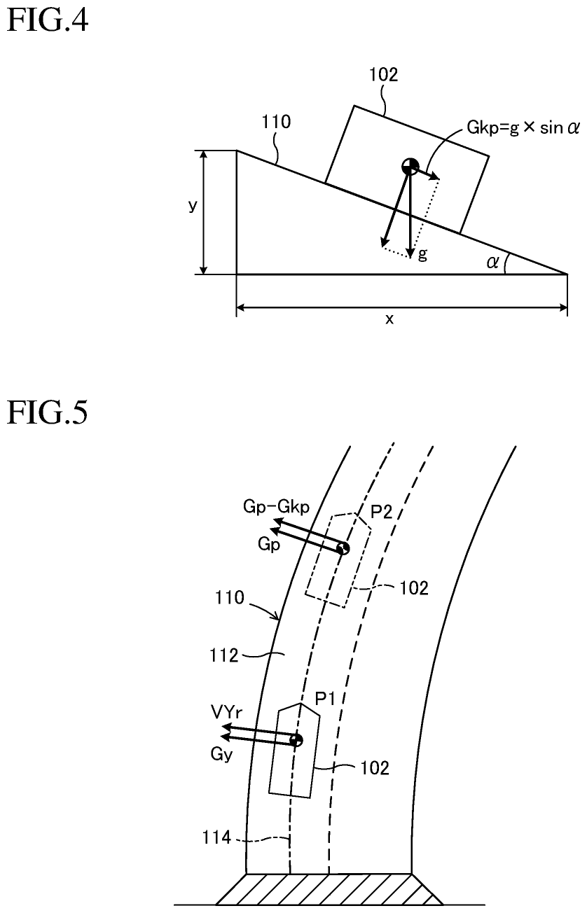

As shown in FIG. 4, when a lateral inclination angle of a road 110 is represented by α and arctan α=y/x, the cant K of the road 110 is (y/x)×100%. Among components of the gravitational acceleration g [m/sec²], a component in the lateral inclination direction of the road 110, ie, the estimated cant lateral acceleration Gkp, is expressed by the following equation (1).

$$\begin{matrix}Gkp = g \times sin α \\ = g \times y / {( {x}^{2} + {y}^{2} )}^{1 / 2}\end{matrix} \qquad ( 1 )$$

For example, if the cant K is 1%, the estimated cant lateral acceleration Gkp is expressed by the following equation (2). From equation (2) below, it can be seen that an estimated cant lateral acceleration Gkp of 0.1 [m/sec²] is generated per 1% cant K.

$$\begin{matrix}Gkp = 9.8 \times 1 / {( {100}^{2} + {1}^{2} )}^{1 / 2} \\ 10 \times 1 / 100 \\ = 0.1 [ m / {sec}^{2} ]\end{matrix} \qquad ( 2 )$$

In step S130, the CPU determines whether or not the LKA is being executed, similarly to step S10. When an affirmative determination is made, the present control proceeds to step S210, and when a negative determination is made, the present control proceeds to step S140.

In step S140, the CPU determines whether or not the estimated cant lateral acceleration Gkp is stably calculated with accuracy higher than or equal to a predetermined standard. When an affirmative determination is made, the present control proceeds to step S180, and when a negative determination is made, the present control proceeds to step S150.

For example, the CPU obtains information about a present vehicle speed V, a vehicle yaw rate Yr, and a vehicle lateral acceleration Gy detected by the vehicle state sensor 70, and calculates an actual cant lateral acceleration Gk by subtracting a lateral acceleration Gy of the vehicle 102 from a product VYr of the vehicle speed and the vehicle yaw rate. Furthermore, when a magnitude of a difference between the estimated cant lateral acceleration Gkp corresponding to the present position of the vehicle 102 and the actual cant lateral acceleration Gk is less than or equal to a difference reference value (positive constant), the CPU determines that the estimated cant lateral acceleration is stably calculated with accuracy higher than or equal to the predetermined standard.

In step S150, the CPU determines whether or not an absolute value of the estimated lateral acceleration Gp exceeds a reference value Gc (positive constant). When a negative determination is made, the flag Fi is set to 0 in step S160, and when an affirmative determination is made, the flag Fi is set to 1 in step S170.

In step S180, the CPU determines whether or not an absolute value of a difference Gp-Gkp between the estimated lateral acceleration Gp and the estimated cant lateral acceleration Gkp exceeds the reference value Gc. When a negative determination is made, the flag Fi is set to 0 in step S190, and when an affirmative determination is made, the flag Fi is set to 1 in step S200.

Further, the CPU executes steps S210, S220, and S250 similarly to steps S140, S150, and S180, respectively.

When a negative determination is made in step S220, the flag Fs is set to 0 in step S230, and when an affirmative determination is made, the flag Fs is set to 1 in step S240.

When a negative determination is made in step S250, the flag Fs is set to 0 in step S260, and when an affirmative determination is made, the flag Fs is set to 1 in step S270.

In the embodiment, each of the determinations in steps S150, S180, S220, and S250 is performed only once. However, in order to prevent the flags Fi and Fs from changing to 1 and 0 in a hunting manner, when negative determinations are made consecutively more than a reference number of times in these steps, and when positive determinations are made consecutively more than the reference number of times in these steps, the control may be advanced to the respective corresponding steps. Furthermore, when negative determinations and affirmative determinations are not made consecutively more than the reference number of times, the flags Fi and Fs may be maintained at their present values.

Further, in the embodiment, the reference values in steps S150, S180, S220, and S250 are all the same Gc. However, the reference values in steps S180 and S250 may be different from the reference values in steps S150 and S220. Further, the reference values in steps S150 and S180 may be different from the reference values in steps S220 and S250, respectively.

### Operation of Embodiment

Next, the operation of the embodiment will be described for various cases in which the LKA is being executed or not.

A: When the LKA is not being Executed

### A-1: When Estimated Cant Lateral Acceleration Gkp is Stably Calculated

A negative determination is made in step S130, but an affirmative determination is made in step S140. When an absolute value of the difference Gp-Gkp between the estimated lateral acceleration Gp and the estimated cant lateral acceleration Gkp is less than or equal to the reference value Gc, a negative determination is made in step S180, and the flag Fi is set to 0 in step S190. Therefore, a negative determination is made in step S20, so that the LKA is executed (S50 to S70).

On the other hand, when an absolute value of the difference Gp-Gkp between the estimated lateral acceleration Gp and the estimated cant lateral acceleration Gkp exceeds the reference value Gc, an affirmative determination is made in step S180, and the flag Fi is set to 1 in step S200. Therefore, an affirmative determination is made in step S20, so that the LKA is suppressed from being executed and not started.

### A-2: When Estimated Cant Lateral Acceleration Gkp is not Stably Calculated

Negative determinations are made in steps S130 and S140. When an absolute value of the estimated lateral acceleration Gp is less than or equal to the reference value Gc, a negative determination is made in step S150, and the flag Fi is set to 0 in step S160. Therefore, a negative determination is made in step S30, so that the LKA is started (S50 to S70).

On the other hand, when an absolute value of the estimated lateral acceleration Gp exceeds the reference value Gc, an affirmative determination is made in step S150, and the flag Fi is set to 1 in step S170. Therefore, an affirmative determination is made in step S30, so that the LKA is suppressed from being executed and not started.

B: When LKA is being Executed

### B-1: When Estimated Cant Lateral Acceleration Gkp is Stably Calculated

Affirmative determinations are made in steps S130 and S210. When an absolute value of the difference Gp-Gkp between the estimated lateral acceleration Gp and the estimated cant lateral acceleration Gkp is less than or equal to the reference value Gc, a negative determination is made in step S250, and the flag Fs is set to 0 in step S260. Therefore, a negative determination is made in step S30, so that the LKA is continued (S50 to S70).

On the other hand, when an absolute value of the difference Gp-Gkp between the estimated lateral acceleration Gp and the estimated cant lateral acceleration Gkp exceeds the reference value Gc, an affirmative determination is made in step S250, and the flag Fs is set to 1 in step S270. Therefore, an affirmative determination is made in step S30, so that the LKA is canceled.

### B-2: When Estimated Cant Lateral Acceleration Gkp is not Stably Calculated

Although an affirmative determination is made in step S130, a negative determination is made in step S210. When an absolute value of the estimated lateral acceleration Gp is less than or equal to the reference value Gc, a negative determination is made in step S220, and the flag Fs is set to 0 in step S230. Therefore, a negative determination is made in step S30, so that the LKA is continued (S50 to S70).

On the other hand, when an absolute value of the estimated lateral acceleration Gp exceeds the reference value Gc, an affirmative determination is made in step S220, and the flag Fs is set to 1 in step S240. Therefore, an affirmative determination is made in step S30, so that the LKA is canceled.

### <When Running on a Curve>

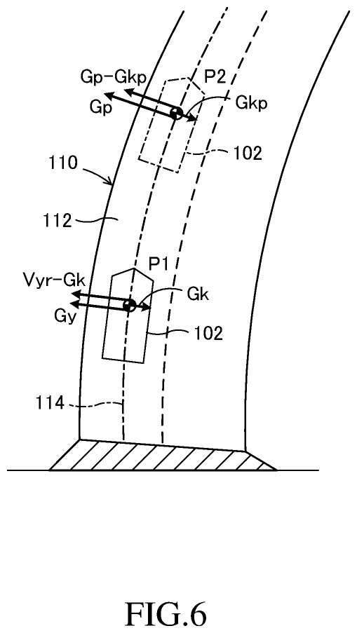

FIGS. 5 and 6 show lateral accelerations of the vehicle 102 when the vehicle runs on a curve without a cant and a curve with a cant, respectively. In FIGS. 5 and 6, the lateral accelerations of the vehicle are illustrated as accelerations in the same direction as the lateral forces acting on the vehicle. In FIGS. 5 and 6, a dashed line indicates a target trajectory 114 of the vehicle 102 running in a lane 112 of a road 110. The vehicle 102 indicated by the solid line indicates a present position P1 of the vehicle, and the vehicle 102 indicated by the two-dot chain line indicates a position where a curvature C of the lane 112 is estimated based on images taken by the camera sensor 12, that is, a future position P2 of the vehicle.

In FIG. 5, since there is no cant on the road 110, an actual cant lateral acceleration Gk and an estimated cant lateral acceleration Gkp are zero. Therefore, a product VYr of a vehicle speed and a vehicle yaw rate is the same as a lateral acceleration Gy of the vehicle 102. Further, a difference Gp-Gkp between an estimated lateral acceleration Gp and the estimated cant lateral acceleration Gkp is the same as the estimated lateral acceleration Gp. Furthermore, when the estimated cant lateral acceleration Gkp is stably calculated with accuracy higher than or equal to the predetermined standard, the difference Gp-Gkp between the estimated lateral acceleration Gp calculated for the position P1 and the estimated cant lateral acceleration Gkp is the same as the lateral acceleration Gy.

In contrast, in FIG. 6, the road 110 has a cant, so an actual cant lateral acceleration Gk and an estimated cant lateral acceleration Gkp are not zero. Therefore, a difference VYr-Gk between a product VYr of a vehicle speed and a vehicle yaw rate and the actual cant lateral acceleration Gk is the same as a lateral acceleration Gy. Further, a difference Gp-Gkp between an estimated lateral acceleration Gp and the estimated cant lateral acceleration Gkp is smaller than the estimated lateral acceleration Gp by Gkp.

Further, when the estimated cant lateral acceleration Gk is stably calculated with accuracy higher than or equal to the predetermined standard, the estimated cant lateral acceleration Gkp calculated for the position P1 is the same as the actual cant lateral acceleration Gk. Therefore, the difference Gp-Gkp between the estimated lateral acceleration Gp calculated for the position P1 and the estimated cant lateral acceleration Gkp is the same as the difference VYr-Gk between the product VYr of the vehicle speed and the vehicle yaw rate and the actual cant lateral acceleration Gk and is the same as the lateral acceleration Gy.

As can be seen from the above description, according to the embodiment, an estimated lateral acceleration Gp of the vehicle is calculated based on a curvature C of a lane in front of the vehicle (S110), and an estimated cant lateral acceleration Gkp is calculated based on a cant K of the lane in front of the vehicle (S120). Further, when a magnitude of a corrected estimated lateral acceleration Gp-Gkp of the vehicle obtained by subtracting the estimated cant lateral acceleration from the estimated lateral acceleration of the vehicle exceeds the determination reference value Gc, the vehicle running control is not performed (S20 to S40, S180, S200, S250 and S270).

As mentioned above, the corrected estimated lateral acceleration Gp-Gkp obtained by subtracting the estimated cant lateral acceleration Gkp from the estimated lateral acceleration Gp of the vehicle is the same as the lateral acceleration Gy corresponding to a centrifugal force reduced by a lateral force acting on the vehicle due to the cant of the lane, that is, the lateral acceleration Gy corresponding to the lateral force actually acting on the vehicle. Therefore, it is possible to prevent the lateral force acting on the vehicle from being determined to exceed the limit of the running control and to prevent the running control from being cancelled unnecessarily even though the lateral force actually acting on the vehicle does not exceed the limit of the running control.

Further, the estimated lateral acceleration Gp of the vehicle is calculated based on the curvature C of the lane in front of the vehicle (S110), and the estimated cant lateral acceleration Gkp is calculated based on the cant K of the lane in front of the vehicle (S120). Therefore, the corrected estimated lateral acceleration Gp-Gkp of the vehicle obtained by subtracting the estimated cant lateral acceleration from the estimated lateral acceleration of the vehicle is the lateral acceleration corresponding to a lateral force that will actually act on the vehicle in the future. Accordingly, as compared to where the determination as to whether or not the running control should be cancelled is made based on the lateral acceleration Gy, this determination can be made earlier, so that it is possible to prevent a delay in determining whether or not to cancel the running control.

In particular, according to the embodiment, if it is determined that the estimated cant lateral acceleration Gkp is not calculated with accuracy higher than or equal to the predetermined standard (S140, S210), when the estimated lateral acceleration Gp of the vehicle exceeds the determination reference value Gc, the running control is not performed (S20 to S40, S170 and S240).

Therefore, in a situation where the calculation accuracy of the estimated cant lateral acceleration is low, it is possible to prevent inappropriate determination of whether or not the running control should be cancelled due to the determination of whether or not the running control should be cancelled being made based on the corrected estimated lateral acceleration Gp-Gkp of the vehicle.

Further, according to the embodiment, the actual cant lateral acceleration Gk(=VYr−Gy) is calculated by subtracting the lateral acceleration Gy of the vehicle from the product of the vehicle speed V and the yaw rate Yr of the vehicle. Furthermore, when the magnitude of the difference between the estimated cant lateral acceleration Gkp calculated for the position where the information on the vehicle lateral acceleration Gy was acquired and the actual cant lateral acceleration Gk exceeds the difference reference value, it is determined that the estimated cant lateral acceleration is not calculated with accuracy higher than or equal to the predetermined standard (S140, S210). Therefore, it is possible to determine whether the estimated cant lateral acceleration is calculated with accuracy higher than or equal to the predetermined standard.

Furthermore, according to the embodiment, a relationship between curvatures C of roads and cants K of the roads based on the road structure regulation is stored, and information on a cant of a lane is obtained from the above relationship based on a curvature of the lane (S120). Therefore, it is possible to obtain information about a cant of the lane without requiring, for example, complicated analysis of images captured by the camera sensor 12.

Although the present disclosure has been described in detail with reference to specific embodiments, it will be apparent to those skilled in the art that the present disclosure is not limited to the above-described embodiment, and various other embodiments are possible within the scope of the present disclosure.

For example, in the above-described embodiment, in step S120, a cant K of a lane when the vehicle 102 passes through a position where a curvature C of the lane was estimated is determined from a map of the relationship between curvatures C of roads and cants K. However, a cant K of a lane may be estimated in any manner known in the art. For example, a virtual line perpendicular to a white line in an image captured by the camera sensor 12 may be set along a road surface, and a cant K of a lane may be estimated by tracking changes in an inclination angle of the virtual line.

In the above-described embodiment, when an absolute value of a difference Gp-Gkp between an estimated lateral acceleration Gp and an estimated cant lateral acceleration Gkp exceeds the reference value Gc, the LKA is not executed. However, the LKA may be executed with a reduced control amount of the LKA.

In the above-described embodiment, although the running control is the LKA, it may also be lane departure prevention control or lane change assistance control.

Further, in the above-described embodiment, an estimated lateral acceleration Gp when the vehicle 102 passes a position where the curvature C of the lane was estimated is calculated by calculating a product CV² of the curvature C of the lane and a square of a vehicle speed V. However, a steering angle θc when the vehicle 102 passes the position where the curvature C of the lane was estimated may be estimated based on the curvature C of the lane, and an estimated lateral acceleration Gp may be calculated using the steering angle θc, a vehicle speed V, and a stability factor of the vehicle determined in advance.

What is claimed is:

1. A running control device for a vehicle comprising a lane information acquisition device that acquires information about a lane in front of the vehicle, an automatic steering device that automatically steers steered wheels, and an electronic control unit that controls the automatic steering device, the electronic control unit is configured to perform a running control in which the electronic control unit calculates a target steering angle for bringing a lateral position of the vehicle with respect to the lane to a target position, and controls the automatic steering device so that a steering angle becomes the target steering angle, wherein
the electronic control unit is configured to calculate a curvature of the lane based on information about the lane, calculate an estimated lateral acceleration of the vehicle based on the curvature of the lane, obtain information about a cant of the lane in front of the vehicle, and calculate an estimated cant lateral acceleration based on the cant of the lane, and is configured not to perform the running control when a magnitude of a corrected estimated lateral acceleration of the vehicle which is obtained by subtracting the estimated cant lateral acceleration from the estimated lateral acceleration of the vehicle exceeds a determination reference value.

2. The running control device for a vehicle according to claim 1, wherein the electronic control unit is configured not to perform the running control when a magnitude of the estimated lateral acceleration of the vehicle exceeds the determination reference value, if the electronic control unit determines that the estimated cant lateral acceleration is not calculated with accuracy higher than or equal to a predetermined standard.

3. The running control device for a vehicle according to claim 1, wherein the electronic control unit is configured to obtain information about vehicle speed, vehicle yaw rate, and vehicle lateral acceleration, calculate an actual cant lateral acceleration by subtracting the vehicle lateral acceleration from a product of the vehicle speed and the vehicle yaw rate, and determine that the estimated cant lateral acceleration is not calculated with accuracy higher than or equal to the predetermined standard when a magnitude of a difference between the actual cant lateral acceleration and the estimated cant lateral acceleration calculated for a position where the information about the vehicle lateral acceleration was acquired exceeds a reference value for the difference.

4. The running control device for a vehicle according to claim 1, wherein the electronic control unit stores a relationship between road curvatures and road cants based on a road structure regulation, and is configured to acquire information about a cant of the lane from the relationship based on the curvature of the lane.

5. A running control method for a vehicle comprising: a step of obtaining information about a lane in front of the vehicle and calculating a target steering angle to bring a lateral position of the vehicle relative to the lane to a target position, and a step of perform a running control including controlling an automatic steering device to automatically steer steered wheels so that a steering angle becomes the target steering angle, wherein
the running control method further comprises a step of calculating a curvature of the lane based on information about the lane to calculate an estimated lateral acceleration of the vehicle based on the curvature of the lane, a step of obtaining information about a cant of the lane in front of the vehicle to calculate an estimated cant lateral acceleration based on the cant of the lane, and a step of executing no running control when a magnitude of a corrected estimated lateral acceleration of the vehicle which is obtained by subtracting the estimated cant lateral acceleration from the estimated lateral acceleration of the vehicle exceeds a determination reference value.
